(19) United States
(12) Patent Application Publication
(10) Pub. No.: US 2009/0194512 A1
(43) Pub. Date: Aug. 6, 2009

(54) Multi-function machine

(75) Inventors: Chia-Lung Kuo, Yunlin County (TW); Pei-Lun Huang, Nantou County (TW); Keng-Hui Chu, Taichung County (TW); Shih-Min Chen, Hsinchu City (TW)

Correspondence Address: BACON & THOMAS, PLLC, 625 SLATERS LANE, FOURTH FLOOR, ALEXANDRIA, VA, 22314-1176, US

(73) Assignee: CONTREL TECHNOLOGY CO., LTD., TAINAN COUNTY (TW)

(21) Appl. No.: 12/155,699

(22) Filed: Jun. 9, 2008

(30) Foreign Application Priority Data
Feb. 1, 2008 (TW) 97104053

(51) Int. Cl. B23K 26/04; B23H 1/00

(52) U.S. Cl. 219/69.17; 219/69.15; 219/121.67; 219/121.85

(57) ABSTRACT

A multi-function machine includes an electrode having a passage, a power supply device electrically connected with the two opposite terminals thereof to the electrode and the workpiece to be processed, a feeder for selectively feeding a gas or fluid to the passage of the electrode, a first laser beam and a second laser beam respectively projected through the passage of the electrode onto the workpiece, and a detection control device for receiving the reflective light wave of the second laser beam reflected by the workpiece.

### BACKGROUND OF THE INVENTION

1. Field of the Invention

The present invention relates to processing machines and more particularly, to a multi-function machine having a laser range-finding function.

2. Description of the Related Art

When using a regular Electrical Discharge Machine (EDM), the electrode of the machine is kept in proximity to the surface of the workpiece that is dipped in a dielectric fluid. The workpiece is cut by generating high frequency sparks through a small gap between the electrode and the workpiece that is filled with the dielectric fluid. This technique allows to machine complicated shapes in hard metals.

The aforesaid electrical discharge machine utilizes electric discharge to cut the workpiece. When a great cutting depth is required, a long processing time is necessary. To shorten the processing time, an improved design of electrical discharge machine with laser cutting tool means is developed. This machine allows spark machining and laser cutting to be simultaneously performed to accelerate the processing.

The aforesaid improved design of electric discharge machine has the advantage of high cutting speed. However, it cannot measure the cutting depth or distance during processing. Therefore, it can only cut through holes, not suitable for other complex structures.

### SUMMARY OF THE INVENTION

The present invention has been accomplished under the circumstances in view. It is the main object of the present invention to provide a multi-function machine, which has a laser range-finding function and can rapidly process different structures.

It is another object of the present invention to provide a multi-function machine, which has a laser range-finding function and is practical for performing precision machining.

To achieve these and other objects of the present invention, the multi-function machine is comprised of an electrode, a power supply device, a feeder, a first laser beam, a second laser beam and a detection control device. The electrode has a connection end, a working end facing a workpiece to be processed, and a passage cut through the connection end and the working end. The power supply device comprises two opposite conducting terminals respectively and electrically connected to the electrode and the workpiece. The feeder is adapted for feeding a gas or fluid to the passage of the electrode. The first laser beam and the second laser beam are respectively projected through the passage of the electrode onto the workpiece in direction from the connection end of the electrode toward the working end of the electrode. The detection control device is adapted for receiving the reflective light wave of the second laser beam reflected by the workpiece. By means of the aforesaid arrangement, the multi-function machine is practical for rapidly processing complex structures.

### BRIEF DESCRIPTION OF THE DRAWING

FIG. 1 is a schematic drawing, showing a multi-function machine in accordance with a first embodiment of the present invention.

FIG. 2 is an applied view of the first embodiment of the present invention, showing a blind hole processing work of the multi-function machine.

FIG. 3 is another applied view of the first embodiment of the present invention, showing a plane machining process of the multi-function machine.

FIG. 4 is a schematic drawing, showing a multi-function machine in accordance with a second embodiment of the present invention.

### DETAILED DESCRIPTION OF THE INVENTION

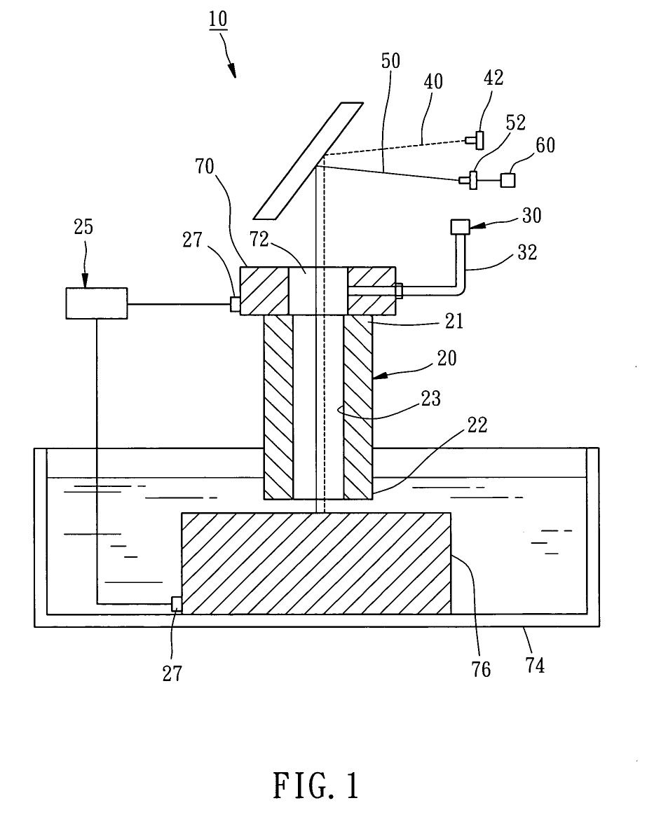

Referring to FIG. 1, a multi-function machine 10 in accordance with a first embodiment of the present invention is shown for electro-discharge machining. The multi-function machine 10 comprises an electrode 20, a power supply device 25, a feeder 30, a first laser beam 40, a second laser beam 50 and a detection control device 60.

The electrode 20 is a cylindrical member made out of copper, having a connection end 21, a working end 22, and a passage 23 cut through the connection end 21 and the working end 22. The connection end 21 is connected to a main shaft 70 of the multi-function machine 10, keeping the passage 23 in communication with an opening 72 of the main shaft 70. The working end 22 faces a workpiece 76 that is put in the machine base 74 of the multi-function machine 10. The main shaft 70 can be driven to reciprocate the electrode 20 in vertical direction or to rotate on its own axis.

The power supply device 25 has two conducting terminals 27. One conducting terminal 27 is the positive pole. The other conducting terminal 27 is the negative pole. The two conducting terminals 27 are respectively and electrically connected to the electrode 20 and the workpiece 76.

The feeder 30 has a connection tubing 32 filled with a gas or fluid and connected to the main shaft 70 so that the gas or fluid can flow through the opening 72 to the passage 23 of the electrode 20.

The first laser beam 40 is a high-power laser beam, for example, Nd:YAG laser or carbon dioxide laser. The second laser beam 50 is a low-power laser. The first laser beam 40 and the second laser beam 50 are respectively produced by laser emitters 42 and 52 and projected into the opening 72 of the main shaft 70. When projected into the opening 72 of the main shaft 70, the first laser beam 40 and the second laser beam 50 go through the passage 23 to the workpiece 76 in direction from the connection end 21 toward the working end 22. The first laser beam 40 and the second laser beam 50 can be projected onto the workpiece 76 either coaxially or non-coaxially.

The detection control device 60 is installed in the laser emitter 52 that emits the second laser beam 50, and adapted for receiving the reflective light wave of the second laser beam 50 reflected by the workpiece 76 and measuring the distance subject to the travel time of the light wave or other ways.

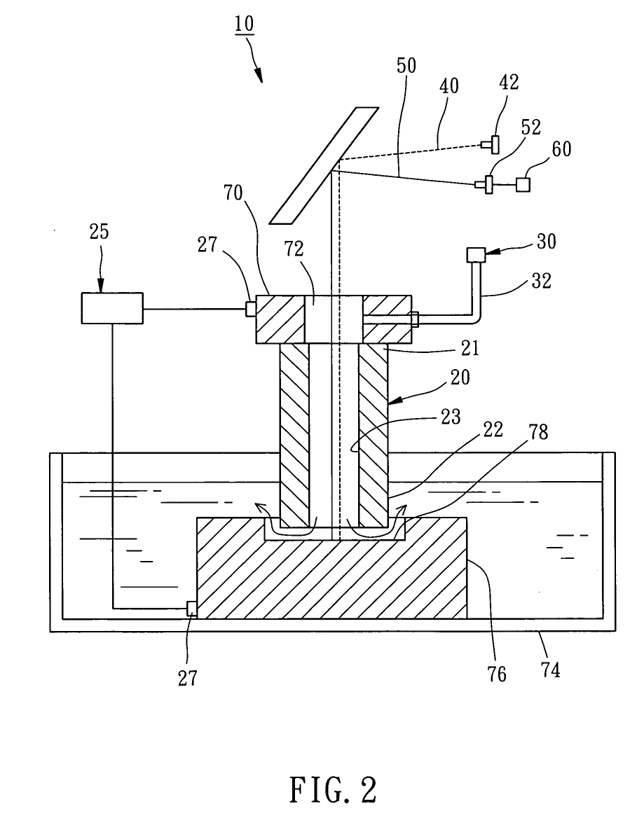

Referring to FIG. 2, when using the multi-function machine 10, positive and negative current respectively go through the conducting terminals 27 to the electrode 20 and the workpiece 76, and the gas or fluid supplied from the feeder 30 goes through the passage 23 of the electrode 20 to the surface of the workpiece 76. When the main shaft 70 is carrying the electrode 20 toward the workpiece 76 to a proximity position, the electrode 20 gives an electric discharge onto the workpiece 76. When the electrode 20 is giving an electric discharge onto the workpiece 76, the first laser beam 40 is cutting the surface of the workpiece 76. By means of the effects of the electric discharge and the first laser beam 40, a corresponding circular blind hole 78 is rapidly formed on the surface of the workpiece 76.

During processing of the workpiece 76 by the electrode 20 and the first laser beam 40, the second laser beam 50 is also projected onto the surface of the workpiece 76, and the reflective light wave goes through the passage 23 of the electrode 20 to the detection control device 60 so that the detection control device 60 can determine the cutting depth of the blind hole 78 by means of calculating the duration from the emitting of the second laser beam 50 till reception of the corresponding reflective light wave.

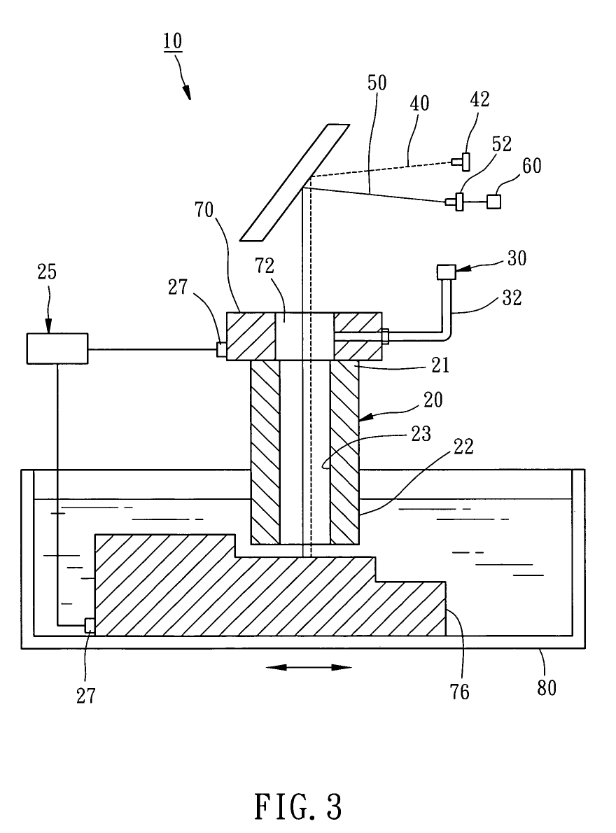

Referring to FIG. 3, when placed the workpiece 76 on a movable table 80, the electrode 20 and the first laser beam 40 can be controlled to perform one type of planar milling, and at the same time the second laser beam 50 is applied for measuring the milling depth. Therefore, the multi-function machine 10 can perform multi-step multi-depth processing.

By means of the application of the second laser beam 50 to provide a feedback signal for measuring the cutting depth, the electric discharge discharged by the electrode 20 and the first laser beam 40 can be simultaneously applied to the workpiece for processing a blind hole or through hole at high precision and high speed. Further, the multi-function machine 10 is suitable for processing different or complex structures.

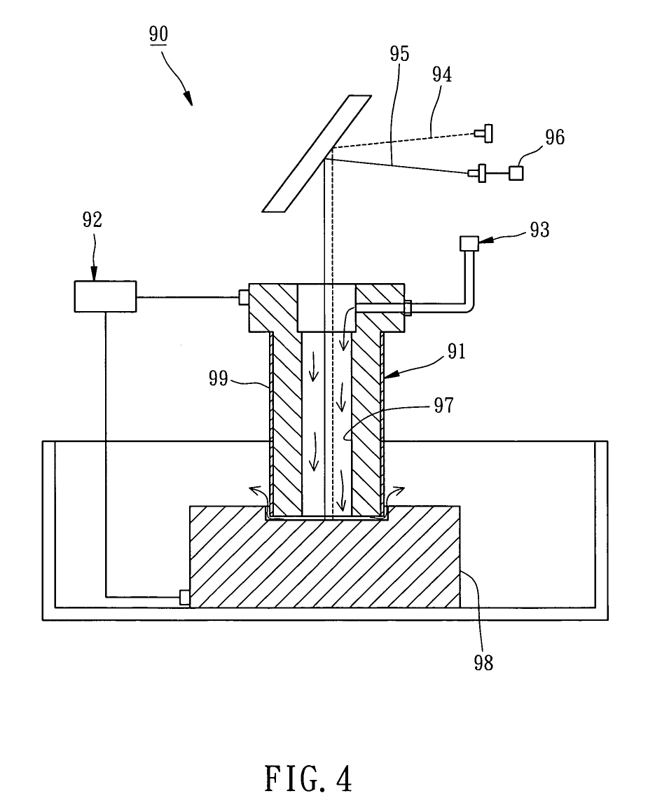

FIG. 4 illustrates a multi-function machine 90 in accordance with a second embodiment of the present invention for electrolytic machining. Substantially similar to the aforesaid first embodiment, the multi-function machine 90 of this second embodiment is comprised of an electrode 91, a power supply device 92, a feeder 93, a first laser beam 94, a second laser beam 95 and a detection control device 96. According to this second embodiment, the feeder 93 is adapted for supplying an electrolyte to the passage 97 of the electrode 91. The first laser beam 94 and the second laser beam 95 are projected through the passage 97 onto the surface of the workpiece 98. The power supply device 92 continuously provides a low-voltage high-ampere current, which flows through the electrolyte between the electrode 91 and the workpiece 98 to dissolve the material of the workpiece 98. Further, an insulator 99 surrounds the periphery of the electrode 91, thereby maintaining the processing quality. This second embodiment achieves the same effects as the aforesaid first embodiment.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A multi-function machine comprising:
an electrode, said electrode having a connection end, a working end facing a workpiece to be processed, and a passage cut through said connection end and said working end;
a power supply device, said power supply device comprising a positive pole terminal and a negative pole terminal, one of said positive pole terminal and said negative pole terminal being electrically connected to said electrode, the other of said positive pole terminal and said negative pole terminal being electrically connected to said workpiece;
a feeder adapted for selectively feeding a gas or fluid to the passage of said electrode;
a first laser beam and a second laser beam being respectively projected through said passage of said electrode onto said workpiece in direction from the connection end of said electrode toward the working end of said electrode; and
a detection control device adapted for receiving the reflective light wave of said second laser beam reflected by said workpiece.

2. The multi-function machine as claimed in claim 1, further comprising a movable table that carries said workpiece.

3. The multi-function machine as claimed in claim 1, further comprising a main shaft connected with the connection end of said electrode for moving said electrode.

4. The multi-function machine as claimed in claim 1, wherein said first laser beam is a high-power laser beam.

5. The multi-function machine as claimed in claim 1, wherein said second laser beam is a low-power laser beam.

6. The multi-function machine as claimed in claim 1, wherein said first laser beam and said second laser beam are coaxially projected onto said workpiece.

7. The multi-function machine as claimed in claim 1, wherein said first laser beam and said second laser beam are non-coaxially projected onto said workpiece.
